(19) United States
(12) Patent Application Publication
(10) Pub. No.: US 2003/0136752 A1
(43) Pub. Date: Jul. 24, 2003

(54) Mechanical anti-snag device for container crane

(75) Inventors: Hoo Gwang Lee, Changwon-shi (KR); Jae Seung Choi, Changwon-shi (KR); Suk Hwan Hwang, Changwon-shi (KR); Il Joon Kwon, Masan-shi (KR)

Correspondence Address: FITZPATRICK CELLA HARPER & SCINTO, 30 ROCKEFELLER PLAZA, NEW YORK, NY, 10112, US

(73) Assignee: DOOSAN HEAVY INDUSTRIES & CONSTRUCTION CO., LTD., Changwon-shi (KR)

(21) Appl. No.: 10/310,148

(22) Filed: Dec. 5, 2002

(30) Foreign Application Priority Data
Dec. 28, 2001 (KR) 10-2001-0086841

(51) Int. Cl. B66C 11/02

(52) U.S. Cl. 212/323

(57) ABSTRACT

The present invention relates to a mechanical anti-snag device for a container crane, which comprises a main driving unit 100 for driving the starting terminals of ropes 104; auxiliary drums 202 respectively for winding the end terminals of said respective ropes 104; torque limiters 203, one end of which is installed respectively along the rotational shaft of said auxiliary drum 202; and auxiliary motors 301, each of which is connected to the rotational shaft of the other end of said torque limiter 203 respectively, wherein said ropes 104, between said main driving unit 100 and the auxiliary drums 20, are made to pass there through while holding up the corners of the head block 107 of the container crane. During the normal transportation of containers, the shaft of said auxiliary motor respectively is firmly fixed in place, and only when there is a need for controlling the trim, list and skew of the head block 107, the fixation as such is released. The torque limiter 203 as above respectively is designed in such a way so that only if the torque of a preset value or higher is applied thereto, the one end thereof connected to the auxiliary drum 202 is put into relative rotation. By way of the present invention with the construction as above, it offers the following advantages: The length of the ropes is longer than that of the conventional device, thereby the amount of energy absorption by the ropes during a snag accident is increased. It prevents environmental contamination, such as outflow of oil. The restart of operation is made easy after a snag accident. It enables control of the trim, list, and skew of the head block by way of using an auxiliary motor.

### FIELD OF THE INVENTION

The present invention relates to a mechanical anti-snag device for a container crane and, more particularly, to a device for controlling trim, list and skew of a head block, and a device for mechanically limiting the impact transmitted to the crane during the occurrence of a snag phenomenon, which is an accident involving a collision of the crane's head block at high speed.

### BACKGROUND OF THE INVENTION

In the past, while operating container cranes at docks, or more particularly while hoisting a head block without a container at high speed, an accident would occur involving a sudden stop due to collision of head block to a protruding obstacle, such as a ship's abnormal cell guide; or a snag accident would occur involving a collision of a head block to the lower structure of a trolley due to the abnormal operation of the braking device in the hoist system. During the accident, an excessive load is generated on the ropes by the rotational inertia energy of the hoist system, and then the load is transmitted to the driving motor, the reducing gear or to the overall structure, which may cause a malfunction or partial damage to the structure.

This type of snag accidents is one that involves a collision of a head block with high speed. As such, it is rather difficult to absorb the energy of impact, transmitted thereto rapidly, by means of stopping the motor by electric signals. Accordingly, there is a need for cutting off or absorbing the energy of impact on the path, of lead transmitted during a snag accident.

FIG. 1 illustrates a hydraulic anti-snag device according to the conventional art. In view of the left-right symmetry, only one side is illustrated. As illustrated, it is designed so that ropes 104 coming out from the main drum 103 hoist a head block 107 by way of middle sheaves 105 connected to the hydraulic cylinders 108, and head block sheaves 109 installed to the head block 107. Here, the one ends of said ropes are held and fixed to the fixation terminals 106. Accordingly, if the load applied to the ropes 104 increases during the occurrence of a snag accident, the pressure in the hydraulic cylinders 108 increases by way of the load transmitted along the middle sheaves 105. If the hydraulic cylinder 108 receives pressure of a certain level or higher, it opens up the valves (not illustrated) and discharges oil, which in the end limits the load transmitted through the rope 104 by allowing temporary movement by the middle sheave 105. Moreover, the hydraulic cylinders 108 respectively are connected to the separate hydraulic pumps, and thus the flow therein can be controlled. By way of increasing or decreasing the amount of fluid, it can carry out the function of pushing and pulling said middle sheave 105. By way of this operation, the hydraulic cylinders 108 also carry out the role of controlling trim, list and skew of the head block.

However, a hydraulic cylinder in itself is not only expensive but also has the disadvantage of environmental contamination by way of outflow of oil during its use.

As another example, there is a method of applying a hex-cell (a honeycomb structure) instead of hydraulic cylinder, which is designed to collapse at a specified pressure or higher. But this structure is also very expensive and impossible to reuse. Furthermore, since it takes long time for replacement, so it has the disadvantage of inefficient operation of the container crane.

Meanwhile, in equipment such as a machine tool, a torque limiter is a device which is incorporated to prevent damage to the mechanical driving members and to reduce the likelihood of accidents during a rapid abnormal increase in load. In general, the torque limiter is designed in such a manner so that the shaft of the driving member is connected to the shaft of the driven member, and it has the function of disallowing transmission of a pre-set torque value or higher by using various principles incorporated into to bearing, pressure devices, etc. In addition to this type of conventional torque limiters, a torque limiter as described in the present invention includes a device having a friction plate of a pair of friction surfaces facing each other, and a pressure unit; and to a device having a friction groove and a friction bar. All of these are devices limiting the torque transmitted thereto when a certain level of torque or higher is generated therein.

### SUMMARY OF THE INVENTION

In resolving said problems, the objective of the present invention lies in providing an anti-snag device, which does not pose a threat of environmental contamination, is capable of repetitive use, and allows prompt restart of operation after a snag accident.

Another objective of the present invention lies in providing a device which can carry out the control function of trim, list and skew of a head block.

In order to achieve said objectives, the mechanical anti-snag device for a container crane according to the present invention comprises a main driving unit for driving the starting terminals of ropes; auxiliary drums, each having an end terminal of said respective rope; torque limiters, one end of which is installed on the rotational shaft of said auxiliary drum, respectively, and the other end of which is fixed to the crane structure, respectively, wherein one end of said torque limiter, which is connected along the rotational shaft of said auxiliary drum, is designed to rotate if a preset value of torque or higher is applied thereto.

Designed as such, the ropes, between said main driving unit and the auxiliary drums, hold the corners of the head block of the container crane while passing there through.

There is additionally a sheave, between the head block of the container crane and the auxiliary drum, for supporting the rope there between at its midpoint. It is preferable to install the auxiliary drum and the main driving unit in the same region, thereby extending the overall length of the ropes and enhancing the shock absorption function of the ropes.

Moreover, with respect to said mechanical anti-snag device, it is preferable to connect one end of the torque limiter to the auxiliary motor, and fix the auxiliary motor to the crane structure. It is preferable to by operated separately only at the time of controlling trim, list, and skew of the head block. Here, it is also preferable to have a brake unit, which stops the auxiliary motor, and a control unit for controlling the operation of said auxiliary motor.

### BRIEF DESCRIPTION OF DRAWINGS

FIG. 1 illustrates a conventional hydraulic anti-snag device.

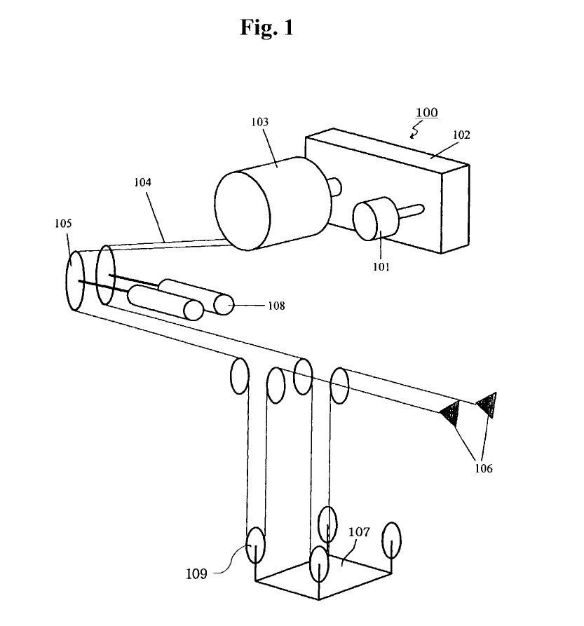

FIG. 2 illustrates a mechanical anti-snag device according to one embodiment of the present invention.

FIG. 3 illustrates a mechanical anti-snag device according to another embodiment of the present invention.

### DESCRIPTION OF THE PREFERRED EMBODIMENTS

Below, the embodiments of the present invention are described in further detail by way of attached drawings.

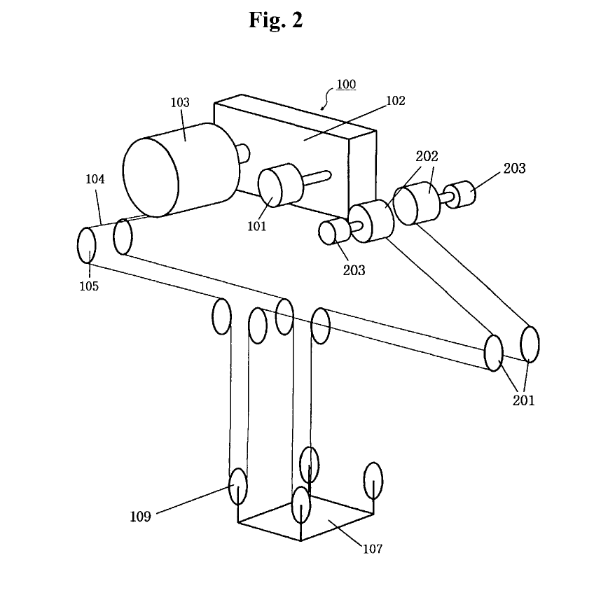

FIG. 2 illustrates a mechanical anti-snag device for a container crane according to one embodiment of the present invention. The head block is symmetrical left to right, and so only one side is illustrated, the other side omitted.

As illustrated, the start terminals of ropes 104 are connected to the main driving device 100 for hoisting the respective corners of the head block 107. The main driving device 100 comprises a main motor 101, a reducing gear 102, and a main drum 103. Particularly, the start terminals of said ropes 104 are wound around the main drum 103. The ropes 104 unwound from the main drum 103 pass there through while being held up by the middle sheave 105, etc., and the end terminals of ropes are wound around the auxiliary drums 202 while holding up the head block 107. Here, the head block 107 is designed in such a way that it is hoisted up by way of ropes with the head block sheaves 109, as an intermediary, which are installed onto the corners thereof.

Meanwhile, the rotational shaft of the auxiliary drum 202 is connected to one end of the torque limiter 203. The other end of the torque limiter 203 is fixed to the frame of the crane (not illustrated). The torque limiter 203 is a device, which allows rotation if the torque applied to the two ends are more than a certain value.

The main driving device 100 is situated in a machine room (not illustrated), which is located at the center upper part of the frame of the container crane. As such, it is protected from the external environment. An assembly of said auxiliary drum 202 together with said torque limiter 203 is installed into the machine room, and a fixed-terminal sheave 201 respectively is installed and connected between said head block 107 and the auxiliary drum 202. In this way, the length of the rope 104 in itself is extended, and hence the shock-absorbing effect during a snag accident could be further enhanced. Moreover, inside the machine room, it is less affected by external environment as compared to that exposed to outside, and hence higher reliability in operation is expected.

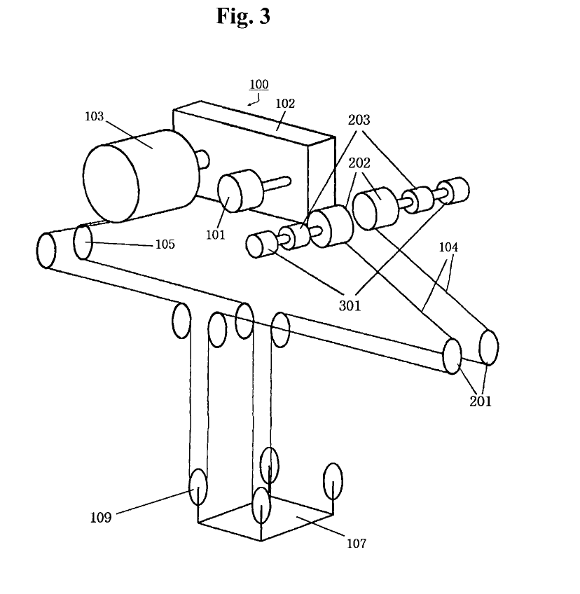

FIG. 3 is illustrates another embodiment of the present invention. The trim, list and skew of the head block 107 cannot be controlled by way of the mechanical anti-snag device presented in FIG. 2. In the present embodiment, it includes an additional device to rectify this situation. In the embodiment, the connecting portion of the fixed terminal of said torque limiter 203 respectively is connected to the auxiliary motor 301, and during normal transportation of containers, the torque limiter 203 and the connecting shaft of the auxiliary motor 301 are firmly fixed in place. Only at the time of controlling the position of the head block 107, it can be used to control the trim, list and skew of the head block 107 by releasing the fixed connection and operating them separately. Here, it is preferable to additionally have a braking unit (not illustrated) and a control unit (not illustrated), wherein the braking state therein is being maintained while the auxiliary motor 301 is generally carrying out the transportation operation of the head block 107, and the brake is released and the amount of rotation of respective auxiliary motors 301 are controlled when there is a need to control the trim, list and skew of the head block.

Meanwhile, in the embodiment of FIG. 3, the auxiliary motor 301 respectively is installed at a position between said head block 107 and the auxiliary drum 202. Further, a modification may be possible, in which the rope 104, connecting the head block 107 and the auxiliary drum 202, is wound around the rotational shaft of the auxiliary motor 301.

By way of the present invention as above, the following advantages can be obtained: (1) The length of the ropes are longer than that of the conventional device, the amount of energy of absorption of ropes during a snag accident is increased. Accordingly, the impact to accessory machines and structures is alleviated. (2) By using a mechanical torque limiter and an auxiliary motor, the problems of environmental contamination, such as outflow of oil, are resolved. (3) It can be reused after a snag accident and is immediately re-operable after removing the cause of the accident. (4) There is no cause for increasing the rotational moment of inertia of the device carrying out the rotational operation. (5) If device for preventing snag damage and for controlling trim, list and skew are installed within the machine room, they are less affected by the external environment as compared to those of the conventional system, thereby enhancing their operational reliability. (6) The present invention can lower costs since it does not require a high-priced hydraulic device, etc.

What is claimed is:

1. A mechanical anti-snag device for a container crane, which comprises a main driving unit for driving the starting terminals of ropes; auxiliary drums respectively for winding the end terminals of said ropes respectively; and torque limiters, one end of which is installed respectively along the rotational shaft of said auxiliary drum, and the other end of which is fixed respectively, wherein said torque limiter respectively has one end, which is installed on the rotational shaft of said auxiliary drum and rotates if a preset value of torque or higher is applied thereto.

2. The mechanical anti-snag device for a container crane according to claim 1, which further comprises sheaves, between said head block and the auxiliary drum, for respectively supporting the rope therein.

3. The mechanical anti-snag device for a container crane according to claim 1 or 2, wherein the other end of said torque limiter is fixed to the shaft of an auxiliary motor.

4. The mechanical anti-snag device for a container crane according to claim 1 or 2, wherein the respective rope between said head block and the auxiliary drum is wound around the rotational shaft of the auxiliary motor.

5. The mechanical anti-snag device for a container crane according to claim 3 or 4, which further comprises a brake unit and a control unit for controlling the operation of said auxiliary motor respectively.
